(19) United States
(12) Patent Application Publication
(10) Pub. No.: US 2023/0205182 A1
(43) Pub. Date: Jun. 29, 2023

(54) GRANULAR WATER USAGE MONITORING AND MANAGEMENT OF WATER SYSTEM USING PER-WATER FLOW DEVICE WATER CONSERVATION POLICIES

(71) Applicant: Sukhamrit Singh, San Jose, CA (US)

(72) Inventor: Sukhamrit Singh, San Jose, CA (US)

(21) Appl. No.: 17/939,871

(22) Filed: Sep. 7, 2022

Related U.S. Application Data
(60) Provisional application No. 63/294,366, filed on Dec. 28, 2021.

(51) Int. Cl. G05B 19/416; E03B 7/07; G08B 21/18

(52) U.S. Cl. CPC G05B 19/416; E03B 7/072; E03B 7/075; G08B 21/18; G05B 2219/37371

(57) ABSTRACT

Several water flow devices are coupled to monitor and control water outlets. The devices are monitored by a water conservation server enforcing water conservation policies independently for each water outlet of a system. The water conservation server can automatically implement changes to a particular water outlet, or just notify a user via email or other mechanisms.

### CROSS-REFERENCE TO RELATED APPLICATIONS

This application claims priority under 35 USC 119(e) to U.S. Provisional Application No. 63,294,366, by Sukhamrit Singh, filed Dec. 28, 2021, which is hereby incorporated by reference in its entirety.

### FIELD OF THE INVENTION

The invention relates generally to computer networking and a plumbing device, and more specifically, to remotely monitoring water flow and controlling water flow individually for each water flow device with water conservation policies.

### BACKGROUND

Households, residences, or commercial properties that receive water supply through a water distribution system usually have water meters installed to measure the overall water usage for the entire property. With droughts becoming a new normal, the urgency to save water is higher than ever. To save water and prevent water wastage, an overall property water usage report provides very little insight into where the water is getting used inside the property.

Currently there is no system that allows households or building owners to create and manage water usage policy inside the building. For more effective water usage monitoring and management inside the homes, residential, or commercial properties (referred to as building here on), a granular water usage monitoring system is needed that can measure water usage for each water outlet in the building.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a water conservation system with granular monitoring and control of water flow, according to an embodiment.

FIG. 2 is a more detailed block diagram illustrating a water flow device of the water conservation system of FIG. 1, according to an embodiment.

FIG. 3 is a more detailed block diagram illustrating a water conservation server of the water conservation system of FIG. 1, according to an embodiment.

FIG. 4 is a flow diagram illustrating a water conservation method with granular monitoring and control of water flow, according to an embodiment.

FIG. 5 is a more detailed flow diagram illustrating a step of enforcing water control policies with water conservation policies, according to an embodiment.

FIG. 6 is an example computing environment for implementing the water conservation system and the water conservation methods, according to an embodiment.

### SUMMARY OF THE DISCLOSURE

The above-mentioned needs are met with a water conservation system that remotely implements a water conservation policy for water flow usage on a per-water outlet basis.

In an embodiment, a first water flow device is coupled to a first water outlet at a first location of a first water system and communicatively coupled to a data communication system. A second water flow device coupled to a first water outlet at a second location of the first water system and communicatively coupled to the data communication system. The devices are monitored by a water conservation server enforcing water conservation policies independently for each water outlet of a system. The water conservation server can automatically implement changes to a particular water outlet, or just notify a user via email or other mechanisms.

Each of the first and second water flow devices can include a flow sensor device set within a water outlet to measure a rate of water flow through the water outlet (e.g., within a chamber of a pipe). The water outlet receives water flow from a water supply. A flow controller device is set to physically reduce and increase water flow rate through the water supply.

A flow sensor module receives data output from the flow sensor device for the water outlet, in an implementation. A network interface transmits the data output to a water conservation server implementing a water conservation policy for the first water system. A flow controller module can send data input to a flow controller device within the water outlet. The network interface receives the data input from the water conservation server, based on the water conservation policy for the water outlet, in response to transmitted data output concerning current water flow rate.

One advantage of the water conservation is to preserve natural water levels with less water usage. Yet another advantage is cost savings for consumers.

### DETAILED DESCRIPTION

### I. Systems for Granular Water Conservation

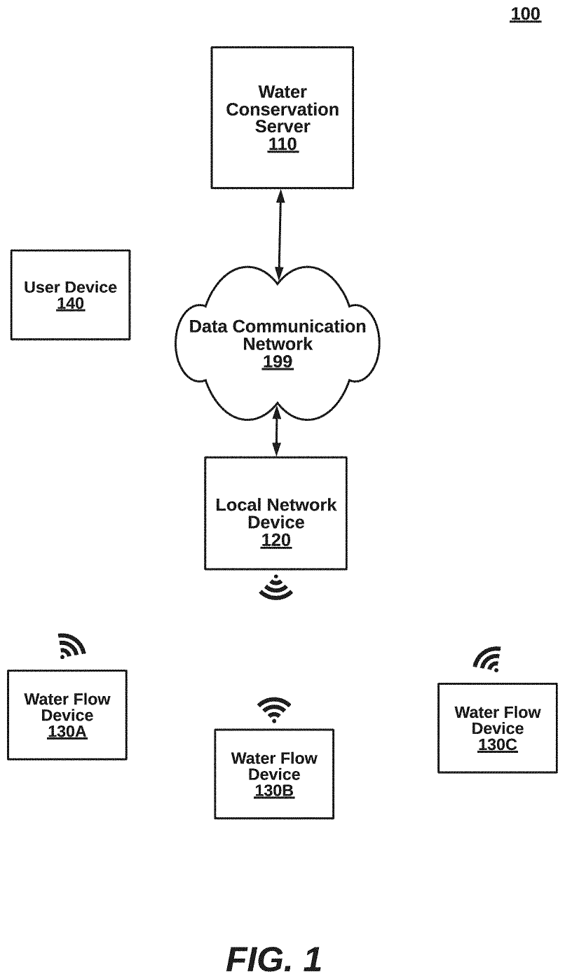

In one embodiment, a water conservation system, such as a Residential Water Usage Monitoring and Management System (RWUMMS) platform shown in FIG. 1, provides granular access to individual water outlets for monitoring and control. The water conservation system 100 comprises a water conservation server 110, a local network device 120, water flow devices 130A-C, and a user device 140, each coupled in communication through a data communication network 199. In general, the water conservation server 110 can be configured to enforce a water conservation policy on each individual water flow device 130A-C, using the user device 140. One of ordinary skill in the art will recognize many possible variations, given the disclosure herein.

The water conservation server 110 actively monitors and controls water flow at individual water outlets according to a water conservation policy. As a cloud-based device providing software-as-a service (SaaS), the water conservation server 110 can serve multiple user accounts, associated with multiple different water systems, and individual water flow devices. For example, a single user can be associated with a single water system having a single outlet or multiple outlets, a single account user can be associated with multiple water systems, and multiple user accounts can be associated with multiple water systems. In other embodiments, the water conservation server 110 is privately owned by an entity located locally on a LAN.

The water conservation policies can treat each node both individually and collectively. In more detail, multiple sensors are clubbed together to act as a single virtual unit (e.g., an apartment, all bathrooms in a building, all exterior sensors). The virtual units can be shown on a user interface as a virtual unit that a user can select for updating parameters. Thus, a water flow device can be aligned for individual water outlet goals and for system-wide goals. For example, a shower head can be restricted during a shower because usage is too high for the session, and also restricted during a shower because usage is too high for a water system for the month. In another example, a landlord for a large apartment complex can restrict water to a single unit because of excessive usage for by unit for the hour or day, or also due to overall usage by the apartment complex for the day or month. Other parameters include current water usage, accumulated water usage, time of the day, and/or information available from external sources such as weather, drought conditions, water levels, and water department data. Predictive analysis can be used to automatically make changes based on estimated upcoming parameters. Water device grouping can be based on geographical location, location inside the building, water usage, type of water outlets, and other logical groupings. Moreover, hot and cold water supply can be separately monitored and controlled at hot and cold water supplies for a water outlet, or be jointly monitored and controlled at the combined water outlet.

Other features of water conservation policies can detect slow drips and when water is accidentally left on. Still another feature can automatically draw a bath at a scheduled time.

The user device 140 provides user access to the user accounts for pre-configuration and real-time interaction. RWUMMS client applications can allow users to register and create accounts using a mobile and/or web application. Users can securely login to the water conservation server 110 to onboard and associate water flow devices with a user account. Each water flow device can be named for ease and visually dragged into groupings on a user interface. Then water conservation rules can be built. In one implementation, a user also associates with a water company account to receive water usage and billing data. In another embodiment, real-time notifications, reports, alerts, or warnings to the user device 140 can advise a user of a current status, and in some cases, request feedback for a manual action (e.g., turn off water system, or turn off spigot). The same information can also be sent directly to a plumber, a water department, a building manager, or the like. Various notification methods include, but are not limited to, email, SMS, push notifications, voice calls, and an audio alarm. The user device 140 can also access reports generated by the water conservation server 110 showing historical usage and predicted usage.

The local network device 120 connects water flow devices 130A-C on a WLAN to the water conservation server 110 on the WAN for remote communications. In an IT environment, each water flow device can have a unique MAC address, IP address, and/or port number registered at the local network device 120. The water conservation server 110 can use the same identifiers or abstracted identifiers, such as nickname of a water flow device, as named by a user (e.g., Son Robert bathroom or Hallway_waterfountain). The local network device 120 periodically receive water usage details from each water flow device installed in the building to exchange water information with the water conservation server 110. In an OT environment, the local network device 120 can be an OT controller that receives and executes policy instructions with electrical signals, resulting from the instructions, sent to a water flow device for mechanical control.

The water flow devices 130A-C each individually monitor and control a single water outlet, in cooperation with the water conservation server 110. The water flow devices 130A-C can be monitor and control water outlets such as taps, showerheads, toilet pipes, garden hoses, other water dispensing outlets and/ or water drainage outlets in the building or outdoors. The water flow devices 130A-C can be installed as a pipe connector and/or as a clamp on unit with a water outlet. Each water flow sensor 130A-C has a unique identifier (e.g., assigned identifier, or hard-coded) and network location. The water flow devices 130A-C can be powered off, deactivated to operate normally, rebooted, or powered on, in various circumstances.

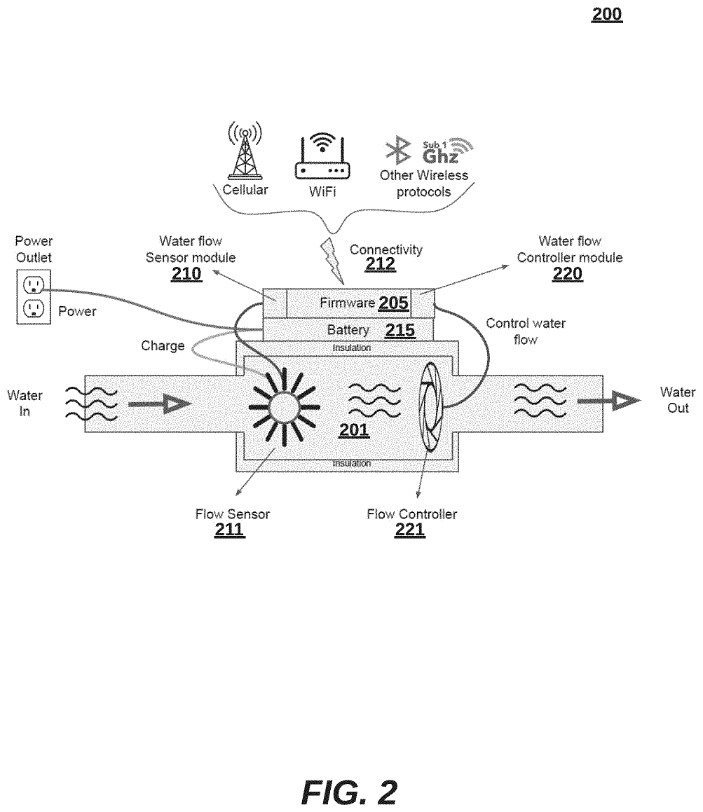

An example water flow device 200 is shown in FIG. 2. In more detail, a flow monitoring module 210 is coupled to receive data output from a flow sensor 211, a flow controlling module 220 is coupled to send output from a flow controller 221. The flow monitoring module 210 and the flow controlling module 220 can be embedded into firmware 205 which utilizes processing hardware and transceiver hardware for connecting to the data communication network 199 (e.g., Wi-Fi). The water flow device 200 can be powered by a battery 215, wired power, or any other appropriate manner. In operation, the flow sensor 211 measures water flow through a chamber 201. Meanwhile, the flow controller 221 opens and closes an aperture to increase or decrease water flow rate, accordingly. Force from water flow can also be leveraged for recharging the battery.

Many different variations to the water flow device 200 can be implemented given the disclosure herein. In one embodiment, the flow sensor 211 and the flow controller 221 are an integrated unit, and in another embodiment, separate units.

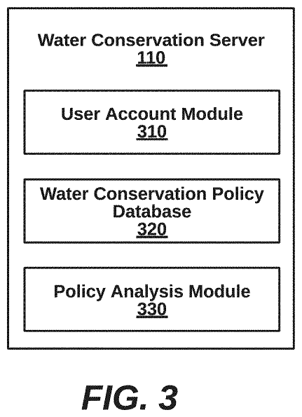

An example water conservation server 110 is shown in FIG. 3. A user account module 310 configures and manages water conservation policies stored in a water conservation policy database 320. A policy analysis module 330 uses real-time and historical data from water flow devices to identify anomalies of water usage.

### II. Methods for Granular Water Conservation

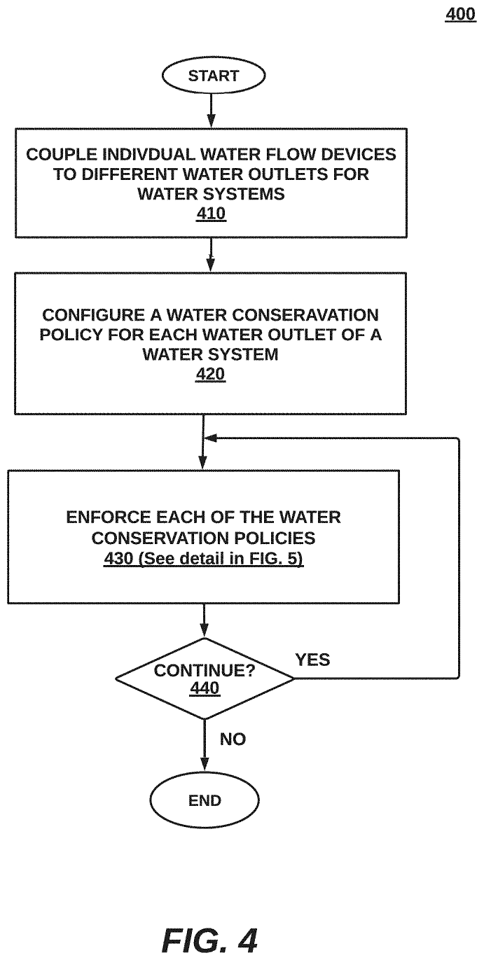

FIG. 4 is a flow diagram illustrating a water conservation method 400 with granular monitoring and control of water flow, according to an embodiment. The method 400 can be implemented, for example, in the water conservation system 100 or another system. The steps shown below are only examples groupings of functionalities, which can be grouped alternatively, and in different orders, with more or less steps. Many other embodiments are possible.

At step 410, individual water flow devices are coupled to different water outlets for one or more water systems. At step 420, a water conservation policy is configured for each water outlet of a water system. At step 430, the water conservation policies are enforced remotely with local actuators, as discussed in more detail below.

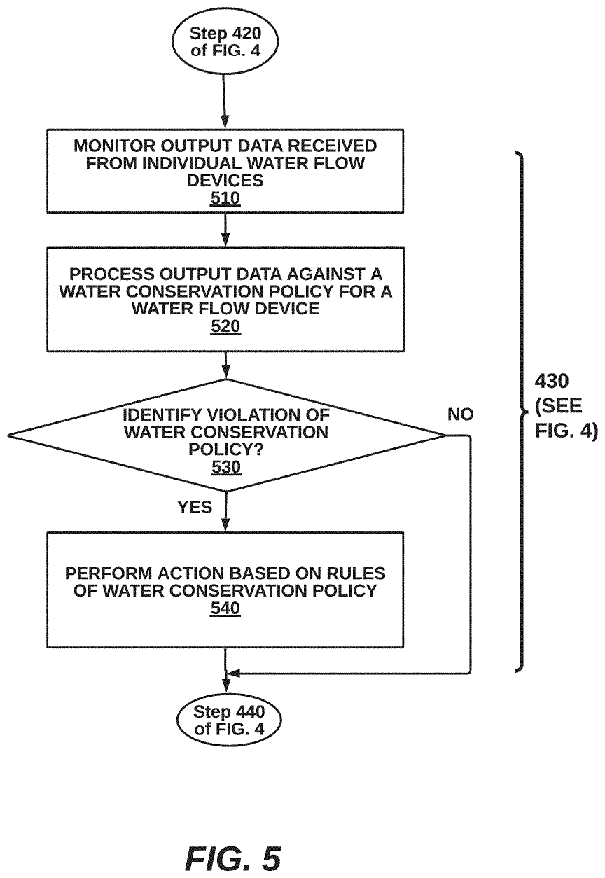

Turning to FIG. 5, an example of the enforcement step is detailed. At step 510, output data received from individual water flow devices is monitored. At step 520, the output data is processed against water conservation policies set for each water flow device. If a policy violation is identified at step 530, then at step 540, an enforcement action is taken based on rules of the corresponding water conservation policy.

### III. Example Computing Environment

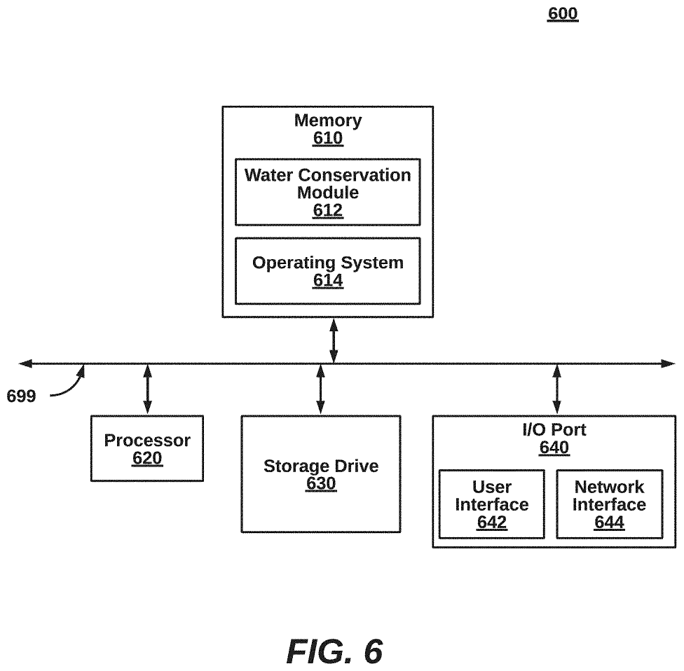

FIG. 6 is an example computing device 600 for implementing the water conservation system and the water conservation methods, according to an embodiment. The computing device 400 is implementable for each of the components of the system 100. The computing device 600 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 600, of the present embodiment, includes a memory 610, a processor 620, a storage drive 630, and an I/O port 640. Each of the components is coupled for electronic communication via a bus 699. Communication can be digital and/or analog, and use any suitable protocol.

The memory 610 further comprises network applications 612 and an operating system 614. The water conservation module 612 can include a web browser, a mobile application, an application that uses networking, a remote application executing locally, a network protocol application, a network management application, a network routing application, or the like. In one case, the water conservation module 612 includes the components described in FIG. 1 or FIG. 2.

The operating system 614 can be one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows 6 or Windows 8), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The processor 620 can be a network processor (e.g., optimized for IEEE 802.11, IEEE 802.11AC or IEEE 802.11AX), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the storage drive 630.

The storage drive 630 can be any non-volatile type of storage such as a magnetic disc, EEPROM (electronically erasable programmable read-only memory), Flash, or the like. The storage drive 630 stores code and data for applications.

The I/O port 640 further comprises a user interface 642 and a network interface 644. The user interface 642 can output to a display device and receive input from, for example, a keyboard. The network interface 644 (e.g. RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. A water conservation system to remotely implement a water conservation policy for water flow usage on a per-water outlet basis, the water conservation system comprising:
a first water flow device coupled to a first water outlet at a first location of a first water system, and communicatively coupling the first water flow device to the data communication system; and
a second water flow device coupled to a second water outlet at a second location of the first water system, and communicatively coupling the second water flow device to the data communication system, wherein a first water conservation policy is configured with rules for the first water flow device distinct from rules for the second water flow device,
wherein each of the first and second water flow devices comprises:
a flow sensor device, coupled to a processor, within a water outlet to measure a rate of water flow through the water outlet, wherein the water outlet receives water flow from a water supply;
a flow controller device, coupled to the processor, to physically reduce and increase water flow rate through the water supply;
a network interface, coupled to the processor; and
a memory, storing source code comprising:
a flow sensor module to receive data output from a flow sensor device for the water outlet, wherein the network interface transmits the data output to a water conservation server, wherein the water conservation server implements a water conservation policy for the first water system, and
a flow controller module to send data input a flow controller device within the water outlet, wherein the network interface receives the data input from the water conservation server, based on the water conservation policy for the water outlet, in response to transmitted data output.

2. The water conservation system of claim 1, wherein only the first water flow device receives instructions for changing water flow.

3. The water conservation system of claim 1, further comprising:
a third water flow device coupled to the first water outlet at the first location of the first water system, according to the water conservation policy.

4. The water conservation system of claim 1, further comprising:
a third water flow device coupled to a third water outlet at a third location of the first water system, according to the water conservation policy.

5. The water conservation system of claim 1, further comprising:
a third water flow device coupled to a third water outlet at a first location of a second water system, according to the water conservation policy.

6. The water conservation system of claim 1, wherein the water conservation server implements water policies for a plurality of different users of a plurality of different water systems.

7. The water conservation system of claim 1, wherein the water conservation server receives parameters for the first water policy from a user device coupled to the data communication network, separately from the first water system.

8. The water conservation system of claim 1, wherein the water conservation server notifies an account holder of actual usage relative to the water conservation policy, in response to a real-time water usage anomaly.

9. The water conservation system of claim 1, wherein the first water flow device and the second water flow device are communicatively coupled to an OT (Operational Technology) server on a local network of the data communication network and the OT server is communicatively coupled to the water conservation server, wherein the OT server implements instructions of the water conservation server, at the first and second water flow devices.

10. The water conservation system of claim 1, wherein the first water system comprises at least one of a residential water system, a commercial water system, and an industrial water system.

11. The water conservation system of claim 1, wherein the water conservation server automatically adjusts water flow at the first location without adjustment at the second location, based on the water flow policy.

12. The water conservation system of claim 1, wherein the water conservation server automatically makes a first adjustment to water flow at the first location and a second adjustment to the water flow at the second location, based on the water flow policy, wherein the first adjustment is distinct from the second adjustment.

13. The water conservation system of claim 1, wherein the water conservation system makes a first adjustment, in real-time, responsive to an instruction from a user device, wherein the user device is located remote from the first location.

14. The water conservation system of claim 1, wherein the first plumbing device includes a pipe section coupled to intercept a water supply pipe.

15. A method in a water conservation system to remotely implement a water conservation policy for water flow usage on a per-water outlet basis, the method comprising:
coupling a first water flow device coupled to a first water outlet at a first location of a first water system, and communicatively coupling the first water flow device to the data communication system;
coupling a second water flow device coupled to a second water outlet at a second location of the first water system, and communicatively coupling the second water flow device to the data communication system
transmitting output data from a first water flow monitor set to measure water flow rate at a first water flow device, and transmitting output data from a second water flow monitor set to measure water flow rate at the second water flow device, to a water conservation server enforcing a water conservation policy, wherein a flow sensor module receives output data from a flow sensor device for the water outlet; and
receiving input data at the first water flow device from the water conservation server, wherein a flow control module receives input data for a flow control device for the water outlet, comprising instructions on increasing or decreasing water flow at the first water flow device, according to the water conservation policy.

16. A non-transitory computer readable medium storing computer source code that, when executed by a processor, performs method in a water conservation system to remotely implement a water conservation policy for water flow usage on a per-water outlet basis, the method comprising:
coupling a first water flow device coupled to a first water outlet at a first location of a first water system, and communicatively coupling the first water flow device to the data communication system;
coupling a second water flow device coupled to a second water outlet at a second location of the first water system, and communicatively coupling the second water flow device to the data communication system
transmitting output data from a first water flow monitor set to measure water flow rate at a first water flow device, and transmitting output data from a second water flow monitor set to measure water flow rate at the second water flow device, to a water conservation server enforcing a water conservation policy, wherein a flow sensor module receives output data from a flow sensor device for the water outlet; and
receiving input data at the first water flow device from the water conservation server, wherein a flow control module receives input data for a flow control device for the water outlet, comprising instructions on increasing or decreasing water flow at the first water flow device, according to the water conservation policy.
